(19) United States
(12) Patent Application Publication
(10) Pub. No.: US 2025/0357498 A1
(43) Pub. Date: Nov. 20, 2025

(54) AIR ELECTRODE/SEPARATOR CONJUGATE AND METAL-AIR RECHARGEABLE BATTERY

(71) Applicant: NGK INSULATORS, LTD., Nagoya-City (JP)

(72) Inventors: Yukari SAKURAYAMA, Nagoya-City (JP); Naomi HASHIMOTO, Nagoya-City (JP)

(73) Assignee: NGK INSULATORS, LTD., Nagoya-City (JP)

(21) Appl. No.: 19/284,853

(22) Filed: Jul. 30, 2025

Related U.S. Application Data
(63) Continuation of application No. PCT/JP2023/036783, filed on Oct. 10, 2023.

(30) Foreign Application Priority Data
Mar. 30, 2023 (JP) 2023-056620

(51) Int. Cl. H01M 4/86; H01M 12/08; H01M 50/431; H01M 50/449

(52) U.S. Cl. CPC H01M 4/8673; H01M 12/08; H01M 50/431; H01M 50/449

(57) ABSTRACT

There is provided an air electrode/separator assembly including a hydroxide ion conductive separator, a catalyst layer that covers one side of the hydroxide ion conductive separator and includes an air electrode catalyst, a hydroxide ion conductive composite material, an electrically conductive material, and a binder, and a gas diffusion electrode arranged on the catalyst layer opposite to the hydroxide ion conductive separator side. The hydroxide ion conductive composite material contains hydrophilic fibers and a plurality of hydroxide ion conductive particles supported on a surface of the hydrophilic fibers in an interconnected manner.

### CROSS-REFERENCE TO RELATED APPLICATIONS

This application is a continuation application of PCT/JP2023/036783 filed Oct. 10, 2023, which claims priority to Japanese Patent Application No. 2023-056620 filed Mar. 30, 2023, the entire contents all of which are incorporated herein by reference.

### BACKGROUND OF THE INVENTION

### 1. Field of the Invention

The present disclosure relates to an air electrode/separator assembly and metal-air secondary battery.

### 2. Description of the Related Art

One candidate for an innovative battery is a metal-air secondary battery. In a metal-air secondary battery, oxygen as a positive electrode active material is supplied from the air, and the space inside the battery container can thus be utilized to a maximum extent for filling the negative electrode active material, so that in principle a high energy density can be achieved. For example, in a zinc-air secondary battery, zinc is used as a negative electrode active material, an alkaline aqueous solution such as potassium hydroxide is used as an electrolytic solution, and a separator (partition) is used to prevent short circuiting between positive and negative electrodes. During discharge, O₂ is reduced on the air electrode (positive electrode) side to generate OH⁻, while zinc is oxidized at the negative electrode to generate ZnO, as shown in the following reaction formulas.

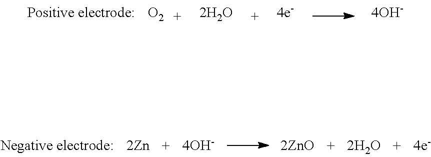

Thus, in metal-air secondary batteries, a metal is used as the negative electrode, and oxygen and water in the air are used as the active materials for the air electrode (positive electrode). At the air electrode, during discharge an oxygen reduction reaction (ORR) that produces hydroxide ions occurs, and during charging an oxygen evolution reaction (OER) that consumes hydroxide ions and produces oxygen occurs. To promote this ORR/OER reaction, a material having hydroxide ion conductivity is used.

Layered double hydroxides (LDHs) are known as one type of hydroxide ion conductive material. LDHs are represented by the formula [M²⁺₁₋ₓM³⁺ₓ(OH)₂][An^{-x/n}·zH₂O] (wherein M²⁺ is a divalent metal ion, M³⁺ is a trivalent metal ion, and An is an anion), and have a characteristic layered structure in which negatively charged anions (negative ions) and water molecules are between positively charged hydroxide layers. LDHs are used as an adsorbent material or a catalyst material, as well as an anion-conducting material by replacing or transferring anions between layers. In particular, when the anions between layers are hydroxide ions, LDHs are used as a hydroxide ion-conducting material. In recent years, air electrodes that use LDHs as a hydroxide ion-conducting material have been proposed.

However, it is known that in zinc secondary batteries such as a zinc-air secondary battery or nickel-zinc secondary battery, metallic zinc in dendrite form precipitates from the negative electrode during charging, and that these metallic zinc dendrites can penetrate the voids of a separator such as a nonwoven fabric and reach the positive electrode, resulting in a short circuit. This short circuit due to zinc dendrites may shorten the repeated charge/discharge life. Moreover, another problem with zinc-air secondary batteries is that carbon dioxide in the air passes through the air electrode, dissolves in the electrolytic solution, and precipitates an alkali carbonate, which can reduce battery performance. Similar problems as described above can occur with lithium-air secondary batteries.

In order to deal with the problems described above, a battery including a layered double hydroxide (LDH) separator that blocks the penetration of zinc dendrites while selectively allowing hydroxide ions to pass through has been proposed. For example, Patent Literature 1 (WO2013/073292) discloses a zinc-air secondary battery including an LDH separator provided between an air electrode and a negative electrode in order to prevent both the short circuit between the positive and negative electrodes due to zinc dendrite and the inclusion of carbon dioxide. Patent Literature 2 (WO2016/076047) discloses a separator structure including an LDH separator fitted or joined to a resin outer frame, wherein the LDH separator has a high denseness such that it has a gas impermeability and/or water impermeability. Moreover, Patent Literature 2 also discloses that the LDH separator can be composited with a porous substrate. Further, Patent Literature 3 (WO2016/067884) discloses various methods for forming an LDH dense membrane on a surface of a porous substrate to obtain a composite material (LDH separator). This method includes a step of uniformly adhering a starting material that can impart a starting point for LDH crystal growth to the porous substrate, and hydrothermally treating the porous substrate in a raw material aqueous solution to form an LDH dense membrane on a surface of the porous substrate. Patent Literature 4 (WO2019/124270) discloses a layered double hydroxide (LDH) separator that includes a porous substrate made of a polymer material and an LDH that clogs up the pores of the porous substrate, and has a linear transmittance at a wavelength of 1000 nm of 1% or more.

Further, in a field of metal-air secondary batteries such as a zinc-air secondary battery, an air electrode/separator assembly in which an air electrode layer is provided on an LDH separator has been proposed. Patent Literature 5 (WO2015/146671) discloses an air electrode/separator assembly including an LDH separator and an air electrode layer thereon, the air electrode layer containing an air electrode catalyst, an electron conducting material, and a hydroxide ion conductive material. Moreover, Patent Literature 6 (WO2020/246177) discloses an air electrode/separator assembly including a hydroxide ion conductive separator, an interface layer that covers one side of the separator and includes a hydroxide ion conductive material and an electrically conductive material, and an air electrode layer that is provided on the interface layer and includes an outermost catalyst layer composed of a layered double hydroxide (LDH) covering a porous current collector and the surface thereof. Patent Literature 5 and Patent Literature 6 also disclose the use of LDH as a hydroxide ion conductive material.

There are also LDH-like compounds that, although they cannot be called as LDHs, are similar to LDHs as hydroxides and/or oxides having a layered crystal structure, and such LDH-like compounds are known to exhibit hydroxide ion conductivity at a similar enough level that they can, together with LDH, be collectively called “hydroxide ion conductive layered compounds”. For example, Patent Literature 7 (WO2020/255856) discloses a hydroxide ion conductive separator that includes a porous substrate and a layered double hydroxide (LDH)-like compound that clogs the pores of the porous substrate, in which the LDH-like compound is a hydroxide and/or oxide having a layered crystal structure containing Mg and one or more elements including at least Ti selected from the group consisting of Ti, Y, and Al. Further, Patent Literature 8 (WO2021/229916) discloses an LDH separator that uses an LDH-like compound containing (i) Ti, Y, and optionally Al and/or Mg, and (ii) an additive element M, which is at least one selected from the group consisting of In, Bi, Ca, Sr, and Ba. In addition, Patent Literature 9 (WO2021/229917) discloses an LDH separator containing a mixture of an LDH-like compound and In(OH)₃, in which the LDH-like compound is a hydroxide and/or oxide having a layered crystal structure containing Mg, Ti, Y, and optionally Al and/or In. The separators disclosed in Patent Literature 7 to Patent Literature 9 are said to have superior alkali resistance compared to conventional LDH separators, and to be able to more effectively suppress short circuiting caused by zinc dendrites.

### CITATION LIST

### Patent Literature

Patent Literature 1: WO2013/073292
Patent Literature 2: WO2016/076047
Patent Literature 3: WO2016/067884
Patent Literature 4: WO2019/124270
Patent Literature 5: WO2015/146671
Patent Literature 6: WO2020/246177
Patent Literature 7: WO2020/255856
Patent Literature 8: WO2021/229916
Patent Literature 9: WO2021/229917

### Non Patent Literature

Non Patent Literature 1: Sun et al., “Single-layer nanosheets with exceptionally high and anisotropic hydroxyl ion conductivity” Sci. Adv. 3, e1602629, 2017

### SUMMARY OF THE INVENTION

As described above, metal-air secondary batteries that include an LDH separator are very advantageous in preventing short circuiting between the positive and negative electrodes due to metal dendrites, as well as preventing the inclusion of carbon dioxide into the battery. Further, such metal-air secondary batteries also have an advantage in that they are capable of inhibiting evaporation of the water contained in the electrolytic solution due to the denseness of the LDH separator. However, since the LDH separator blocks the permeation of the electrolytic solution into the air electrode, the electrolytic solution is absent in the air electrode layer. Therefore, compared with a zinc-air secondary battery including a general separator (for example, a porous polymer separator) that allows permeation of the electrolytic solution into the air electrode, the hydroxide ion conductivity tends to be low, which leads to a decrease in charge/discharge performance. Therefore, there is a need for an air electrode/separator assembly that exhibits excellent charge/discharge performance while having the advantages of using an LDH separator.

In recent years, the use of LDHs as a hydroxide ion conductive material for air electrodes has been proposed (see Patent Literature 5 and Patent Literature 6), but there is still much room for improvement in LDHs. LDHs are generally in the form of platy particles having an arbitrary planar shape. When LDH platy particles are used as an anion conductive material such as a hydroxide ion conductive material, it is desirable for these platy particles to be in contact with each other, and in particular, to be continuous in the planar direction by overlapping or contacting to each other. On this point, in the prior art there have been reports that the hydroxide ion conductivity in the planar direction is improved by applying nanoscale detached pieces of the LDH layer to the surface of a thin film (e.g., Non-Patent Literature 1 (Sun et al., “Single-layer nanosheets with exceptionally high and anisotropic hydroxyl ion conductivity” Sci. Adv. 3, e1602629, 2017)). However, when using LDH platy particles as a hydroxide ion conductive material in the air electrode of a metal-air battery, it is difficult to precisely control the state in which the LDH platy particles are present by simply mixing the LDH with the raw material powder of the air electrode catalyst and the like, and it is particularly difficult to arrange the LDH platy particles continuously in the planar direction. For this reason, there has been the problem that the hydroxide ion conductivity of the LDH could not be fully utilized in the air electrode.

The inventors have recently discovered that by constructing an air electrode/separator assembly using a hydroxide ion conductive composite material in which a number of hydroxide ion conductive particles are supported on the surface of hydrophilic fibers in an interconnected manner, it is possible to reduce charge/discharge overvoltage when used in a metal-air secondary battery.

Therefore, an object of the present disclosure is to provide an air electrode/separator assembly that can reduce charge/discharge overvoltage when used in a metal-air secondary battery.

The present disclosure provides the following aspects:

### Aspect 1

An air electrode/separator assembly comprising:
a hydroxide ion conductive separator;
a catalyst layer that covers one side of the hydroxide ion conductive separator and comprises an air electrode catalyst, a hydroxide ion conductive composite material, an electrically conductive material, and a binder; and
a gas diffusion electrode arranged on the catalyst layer opposite to the hydroxide ion conductive separator side, wherein
the hydroxide ion conductive composite material comprises:
hydrophilic fibers; and
a plurality of hydroxide ion conductive particles supported on a surface of the hydrophilic fibers in an interconnected manner.

### Aspect 2

The air electrode/separator assembly according to aspect 1, wherein the hydrophilic fibers are at least one selected from the group consisting of cellulose nanofibers, chitin nanofibers, and chitosan nanofibers.

### Aspect 3

The air electrode/separator assembly according to aspect 1 or 2, wherein the hydrophilic fibers are cellulose nanofibers.

### Aspect 4

The air electrode/separator assembly according to any one of aspects 1 to 3, wherein the hydrophilic fibers have a length of from 0.1 to 100 μm.

### Aspect 5

The air electrode/separator assembly according to any one of aspects 1 to 4, wherein the hydrophilic fibers have a length of from 0.2 to 50 μm.

### Aspect 6

The air electrode/separator assembly according to any one of aspects 1 to 5, wherein the hydrophilic fibers have a length of from 5 to 50 μm.

### Aspect 7

The air electrode/separator assembly according to any one of aspects 1 to 6, wherein the hydroxide ion conductive particles are composed of a layered double hydroxide (LDH).

### Aspect 8

The air electrode/separator assembly according to aspect 7, wherein the layered double hydroxide (LDH) comprises at least two elements selected from the group consisting of Ni, Fe, Mg, Al, and Ti as constituent elements.

### Aspect 9

The air electrode/separator assembly according to aspect 8, wherein the at least two elements comprise Mg and Al.

### Aspect 10

The air electrode/separator assembly according to any one of aspects 1 to 9, wherein a content of the hydroxide ion conductive composite material in the catalyst layer is from 10 to 40% by volume based on a total amount in terms of solid matter of the air electrode catalyst, the hydroxide ion conductive composite material, the electrically conductive material, and the binder.

### Aspect 11

The air electrode/separator assembly according to any one of aspects 1 to 10, wherein a content of the hydroxide ion conductive composite material in the catalyst layer is from 10 to 30% by volume based on a total amount in terms of solid matter of the air electrode catalyst, the hydroxide ion conductive composite material, the electrically conductive material, and the binder.

### Aspect 12

The air electrode/separator assembly according to any one of aspects 1 to 11, wherein the hydroxide ion conductive separator is a layered double hydroxide (LDH) separator.

### Aspect 13

The air electrode/separator assembly according to aspect 12, wherein the LDH separator is composited with a porous substrate.

### Aspect 14

A metal-air secondary battery comprising:
the air electrode/separator assembly according to any one of aspects 1 to 13;
a metal negative electrode; and
an electrolytic solution, wherein
the electrolytic solution is separated from the air electrode layer by the hydroxide ion conductive separator interposed therebetween.

### BRIEF DESCRIPTION OF THE DRAWINGS

FIG. 1 is a schematic cross-sectional view conceptually showing an air electrode/separator assembly according to one aspect of the present disclosure.

FIG. 2 is a diagram conceptually showing a microstructure of a catalyst layer in the air electrode/separator assembly according to one aspect of the present disclosure, in which, in order to focus on the microstructure of the catalyst layer, other components such as a gas diffusion electrode and a current collector are omitted, and for the same purpose, a portion of an LDH separator is depicted as being removed near the catalyst layer.

FIG. 3 is an XRD profile obtained for Mg—Al-LDH produced in Example 1.

FIG. 4 is an SEM image (magnification: 25000×) of cellulose nanofibers (CNF) supporting the Mg—Al-LDH produced in Example 1.

FIG. 5 is an SEM image (magnification: 50000×) of CNF supporting the Mg—Al-LDH produced in Example 1.

FIG. 6 is an SEM image showing the measurement point in EDX quantitative analysis of the Mg—Al-LDH-supported CNF produced in Example 1.

FIG. 7 is an EDX profile obtained for the Mg—Al-LDH produced in Example 1.

FIG. 8 shows the charge/discharge evaluation results of zinc-air secondary batteries produced in Examples 1 to 3.

### DETAILED DESCRIPTION OF THE INVENTION

Air electrode/separator assembly

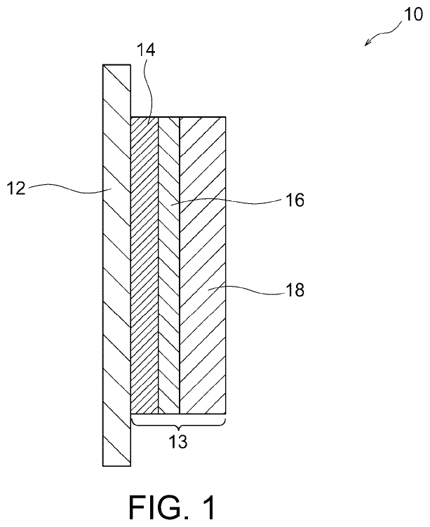

One aspect of an air electrode/separator assembly is shown in FIG. 1. The air electrode/separator assembly 10 shown in FIG. 1 includes a hydroxide ion conductive separator 12 and an air electrode layer 13. The air electrode layer 13 includes a catalyst layer 14, a gas diffusion electrode 16, and optionally an air electrode current collector 18.

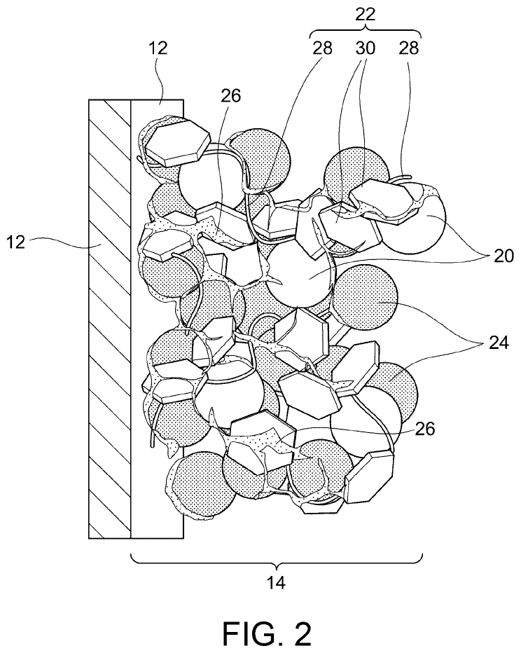

As conceptually shown in FIG. 2, the catalyst layer 14 includes an air electrode catalyst 20, a hydroxide ion conductive composite material 22, an electrically conductive material 24, and a binder 26, and covers one side of the hydroxide ion conductive separator 12. The hydroxide ion conductive composite material 22 contains hydrophilic fibers 28 and a plurality of hydroxide ion conductive particles 30 supported on the surface of the hydrophilic fibers 28 in an interconnected manner. In this way, by constructing an air electrode/separator assembly 10 using a hydroxide ion conductive composite material 22 in which a plurality of hydroxide ion conductive particles 30 are supported so as to be interconnected with each other on the surface of the hydrophilic fibers 28, it is possible to achieve a reduction in charge/discharge overvoltage when used as a metal-air secondary battery.

That is, as mentioned above, LDHs are generally in the form of platy particles having an arbitrary planar shape. When LDH platy particles are used as an anion conductive material such as a hydroxide ion conductive material, it is desirable for these platy particles to be in contact with each other, and in particular, to be continuous in the planar direction by overlapping or contacting to each other. However, when using LDH platy particles as a hydroxide ion conductive material in the air electrode of a metal-air battery, it is difficult to precisely control the state in which the LDH platy particles are present by simply mixing the LDH with the raw material powder of the air electrode catalyst and the like, and it is particularly difficult to arrange the LDH platy particles continuously in the planar direction. For this reason, there has been the problem that the hydroxide ion conductivity of the LDH could not be fully utilized in the air electrode. In this regard, with the present disclosure, it is possible to make the hydroxide ion conductive particles 30 (for example, LDH platy particles) into a continuous body (i.e., an aggregate of particles that are continuously interconnected with each other in a planar direction) by synthesizing and supporting the hydroxide ion conductive particles 30 (for example, LDH platy particles) so that they are interconnected with each other (for example, so that the faces of the LDH platy particles are parallel to each other) on the surface of the hydrophilic fibers 28. This allows hydroxide ion conductive particles such as LDH platy particles to be utilized as a continuous body, which was difficult with conventional technology, and excellent anion conductivity (particularly hydroxide ion conductivity) to be achieved. Therefore, by using the hydroxide ion conductive composite material 22 having such a configuration as a hydroxide ion conductive material for the air electrode of a metal-air battery, the hydroxide ion conductivity of the air electrode layer 13 (particularly the catalyst layer 14) can be improved. Further, by configuring the air electrode/separator assembly 10 with such an air electrode layer 13 (particularly the catalyst layer 14), when used in a metal-air secondary battery, the reaction rate of the charge/discharge reaction increases due to the improvement in hydroxide ion conductivity, and as a result, it is thought that the reduction in the charge/discharge overvoltage is achieved.

The hydroxide ion conductive separator 12 is not particularly limited as long as it is a separator capable of isolating the air electrode layer 13 and the negative electrode layer in a zinc-air secondary battery in a manner that allows hydroxide ions to be conducted therebetween. However, typically, the hydroxide ion conductive separator 12 is a separator that includes a hydroxide ion conductive solid electrolyte, and selectively allows hydroxide ions to pass therethrough solely by utilizing hydroxide ion conductivity. A preferred hydroxide ion conductive solid electrolyte is a layered double hydroxide (LDH) and/or an LDH-like compound. Therefore, it is preferred that the hydroxide ion conductive separator 12 is an LDH separator. Herein, “LDH separator” is defined as a separator containing an LDH and/or LDH-like compound, which selectively allows hydroxide ions to pass therethrough solely by the hydroxide ion conductivity of the LDH and/or LDH-like compound. Herein, “LDH-like compound” refers to a hydroxide and/or oxide having a layered crystal structure that, although it might not be called as an “LDH”, does have hydroxide ion conductivity, and can be considered equivalent to an LDH. So, in a broad sense, “LDH” can be construed as encompassing not only LDHs, but LDH-like compounds as well. The LDH separator is preferably composited with a porous substrate. Therefore, the LDH separator preferably further includes a porous substrate, and is composited with the porous substrate in a form in which the pores of the porous substrate are filled with the LDH and/or LDH-like compound. That is, in a preferred LDH separator, the pores of the porous substrate are clogged up by the LDH and/or LDH-like compound so as to exhibit hydroxide ion conductivity and gas impermeability (and therefore function as an LDH separator exhibiting hydroxide ion conductivity). The porous substrate is preferably made of a polymer material, and it is particularly preferred that the LDH and/or LDH-like compound is incorporated throughout the entire thickness of the porous substrate made of a polymer material. For example, known LDH separators such as those disclosed in Patent Literature 1 to Patent Literature 9 can be used. The thickness of the LDH separator is preferably from 5 to 100 μm, more preferably from 5 to 80 μm, further preferably from 5 to 60 μm, and particularly preferably from 5 to 40 μm.

The catalyst layer 14 includes an air electrode catalyst 20 (e.g., a catalyst for charging and a catalyst for discharging), a hydroxide ion conductive composite material 22, an electrically conductive material 24, and a binder 26.

The air electrode catalyst 20 included in the catalyst layer 14 has a spherical, platy, or fibrous form, and is dispersed throughout the catalyst layer 14. In the catalyst 20, separate catalysts may be used for charging and discharging, or one catalyst may be used for both the charging and the discharging reactions. The catalyst 20 may also serve as the electrically conductive material 24 or the hydroxide ion conductive composite material 22. The catalyst 20 is not particularly limited as long as it has a catalytic activity for each reaction, but for discharging, a carbon-based catalyst, an oxide catalyst, or a metal catalyst is preferable, while for charging, a hydroxide catalyst, an oxide catalyst, or a carbon-based catalyst is preferable. The catalyst 20 is preferably in the form of fine particles to increase the reaction field. Specifically, the particle size of the catalyst 20 is preferably 5 μm or less, more preferably from 0.5 nm to 3 μm, and further preferably from 1 nm to 3 μm.

The hydroxide ion conductive composite material 22 included in the catalyst layer 14 is a composite material that forms hydroxide ion conducting paths throughout the catalyst layer 14. The hydroxide ion conductive composite material 22 contains hydrophilic fibers 28 and a plurality of hydroxide ion conductive particles 30 that are interconnected with each other and supported on the surface of the hydrophilic fibers 28. The “plurality of hydroxide ion conductive particles that are interconnected with each other and supported” can be specified as the hydroxide ion conductive particles 30 that are supported on the surface of the hydrophilic fibers 28 and that are in contact with an adjacent hydroxide ion conductive particle 30 in at least one location. The hydrophilic fibers 28 are not particularly limited as long as hydroxyl groups (OH groups) are coordinated or can be coordinated to the surface of the hydrophilic fibers 28. The hydroxide ion conductive particles 30 (for example, LDH platy particles) can be synthesized and supported on the surface of such hydrophilic fibers 28 by a coprecipitation method or the like so that they are interconnected with each other (for example, so that the faces of the LDH platy particles are parallel to each other) on the surface of the hydrophilic fibers 28. That is, by using the hydrophilic fibers 28, the hydroxide ion conductive particles 30 (for example, LDH platy particles) can be made into a continuous body (i.e., an aggregate of particles that are continuously interconnected with each other in a planar direction). This is thought to be because the hydroxyl groups (OH groups) coordinated to the surface of the hydrophilic fibers 28 change into a form (O-group) in which the hydrogen ion has been removed by the action of a strong base such as NaOH during coprecipitation, for example, and the formed O-groups are then electrostatically attracted to the metal ions in the raw material aqueous solution containing the constituent elements of the LDH, resulting in the precipitation of LDH platy particles on the surface.

Preferred examples of the hydrophilic fibers 28 include cellulose nanofibers, chitin nanofibers, chitosan nanofibers (CNF), and combinations thereof, and more preferably cellulose nanofibers (CNF). The length of the hydrophilic fibers 28 is not particularly limited, but is preferably from 0.1 to 100 μm, more preferably from 0.1 to 50 μm, further preferably from 0.2 to 50 μm, particularly preferably from 5 to 50 μm, and most preferably from 10 to 50 μm. That is, the hydrophilic fibers 28 can be short (e.g., several hundreds of nm) or long (e.g., several tens of μm) in fiber length depending on the size of the raw material obtained, but a longer fiber length is preferred. This is because it is thought that a longer fiber length increases the hydroxide ion conduction distance, so that the hydroxide ions are sufficiently distributed throughout the catalyst layer 14 without interruptions to the hydroxide ion conduction paths required for the charge/discharge reaction in the catalyst layer 14.

The hydroxide ion conductive particles 30 are not particularly limited as long as they are particles having hydroxide ion conductivity, but as described above, they are preferably composed of a layered double hydroxide (LDH). In this case, the hydroxide ion conductive particles 30 can be LDH platy particles. The LDHs that make up the hydroxide ion conductive particles 30 preferably contain at least two elements selected from the group consisting of Ni, Fe, Mg, Al, and Ti as constituent elements, and it is more preferable that these at least two elements include Mg and Al. By including at least the two elements Mg and Al, better anion conductivity (e.g., hydroxide ion conductivity) can be realized. In this case, the atomic ratio of Al/Mg determined by energy dispersive X-ray spectroscopy (EDX) of Mg—Al-LDH is preferably 0.30 to 0.55, and more preferably 0.40 to 0.55. When Mg—Al-LDH having an atomic ratio within this range is used as the hydroxide ion conductive material for the air electrode of a metal-air battery, the hydroxide ion conductivity can be particularly effectively improved, and as a result, the reaction rate of the charge/discharge reaction can be further increased and charge/discharge overvoltage can be further reduced. In the LDH, the anion between the layers is preferably a hydroxide ion. That is, the LDH is preferably represented by the formula [M²⁺₁₋ₓM³⁺ₓ(OH)₂][An^{-x/n}·zH₂O] (wherein M²⁺ includes Mg²⁺, M³⁺ includes Al³⁺, A^{-x/n} is OH, 0.2≤x≤0.4, and z is any real number exceeding 0). The LDH can be synthesized by coprecipitation. For example, this may be performed by adding a raw material aqueous solution containing the constituent elements of the LDH dropwise into an aqueous solution containing carbonate ions and a fiber material such as cellulose nanofiber (CNF) under a pH condition of from 9.5 to 12, and carrying out a hydrothermal treatment. For example, an aqueous NaOH solution may be used to adjust the pH. The crystal size, crystallinity and/or orientation of the resulting reaction product may be controlled by performing an aging treatment such as stirring, heating and pressurization as necessary.

The content of the hydroxide ion conductive composite material contained in the catalyst layer 14 is preferably an amount that allows ion conducting paths to be formed within the catalyst layer. Specifically, in the catalyst layer 14, the content of the hydroxide ion conductive composite material 22 is, based on the total amount in terms of solid matter of the air electrode catalyst 20, the hydroxide ion conductive composite material 22, the electrically conductive material 24, and the binder 26 (when this total amount is taken to be 100%), preferably from 10 to 40% by volume, and more preferably from 10 to 30% by volume.

The electrically conductive material 24 contained in catalyst layer 14 is preferably at least one selected from the group consisting of an electrically conductive ceramic and a carbon-based material. Preferred examples of the electrically conductive ceramic include LaNiOs, LaSr₃Fe₃O₁₀, and the like. Examples of the carbon-based material include carbon black, graphite, carbon nanotubes, graphene, reduced graphene oxide, Ketjen black and arbitrary combinations thereof.

A known binder resin can be used as the binder 26 contained in the catalyst layer 14. Examples of the organic polymer include a butyral-based resin, a vinyl alcohol-based resin, a cellulose, a vinyl acetal-based resin, polytetrafluoroethylene, polyvinylidene fluoride, and the like, and a butyral-based resin, polytetrafluoroethylene, and polyvinylidene fluoride are preferable. As shown conceptually in FIG. 2, it is preferred that the binder 26 is present in such a manner that it binds the air electrode catalyst 20, the hydroxide ion conductive composite material 22, and the electrically conductive material 24 to each other and that these components are adequately exposed so that they can come into contact with air.

The catalyst layer 14 can be produced by preparing a paste containing the air electrode catalyst 20, hydroxide ion conductive composite material 22, electrically conductive material 24, and binder 26, and applying the paste onto the surface of the hydroxide ion conductive separator 12. The paste can be prepared by appropriately adding the organic polymer (binder resin) and an organic solvent to a mixture of the air electrode catalyst 20, hydroxide ion conductive composite material 22, and electrically conductive material 24, and using a known kneader such as a three-roll mill or jet mill. Preferred examples of the organic solvent include alcohols such as butyl carbitol and terpineol, acetic acid ester-based solvents such as butyl acetate. The application of the paste onto the hydroxide ion conductive separator 12 can be carried out by printing. This printing can be carried out by various known printing methods, but a screen printing method is preferred.

It is preferred that the gas diffusion electrode 16 includes a microporous layer (MPL) and a substrate for gas diffusion, and is formed on one side of the catalyst layer 14 so that the microporous layer (MPL) is in contact with the catalyst layer 14. The substrate for gas diffusion is not particularly limited as long as it has electron conductivity and is a porous material that can diffuse oxygen throughout the electrode, and is preferably carbon paper or a porous metallic body. From the viewpoint of reducing energy density while securing gas diffusivity, the thickness of the substrate for gas diffusion is preferably 0.4 μm or less, and more preferably 0.1 to 0.3 μm. The porosity of the substrate for gas diffusion is, from the viewpoint of the permeation amount of the gas, preferably 70% or more, more preferably from 70 to 90%, and particularly preferably from 75 to 85%. The porosity values described above enable securing both excellent gas diffusibility and a wide reaction region. Moreover, the generated water is less likely to clog up pores due to the large pore spaces. The porosity can be measured by a mercury intrusion method. The microporous layer is not particularly limited as long as it has electron conductivity and water repellency to an extent that water generated by an air electrode reaction does not penetrate into the substrate for gas diffusion, but preferably contains a carbon material and polytetrafluoroethylene (PTFE).

A porous material having general electrical conductivity can be used for the air electrode current collector 18, which is preferably made of metal. Preferred examples of the metal constituting the air electrode current collector 18 include stainless steel, titanium, nickel, brass, copper, and the like. The form of the air electrode current collector 18 when made of metal is not particularly limited as long as its electrical conductivity and air permeability are secured, but preferred examples include a porous metal, a metal mesh, and a metal plate having an uneven shape. Examples of the porous metal include a metallic product having open pores, such as a foamed metal and a sintered porous metal. Examples of the metal mesh include a laminate product of a metal mesh or a metal mesh in laminated form. A porous metal plate such as a punched metal that has been processed into a wavy shape may be used as the metal plate having an uneven shape.

As described above, the air electrode/separator assembly 10 is preferably used for a metal-air secondary battery. That is, a preferred aspect of the present disclosure provides a metal-air secondary battery that includes an air electrode/separator assembly 10, a metal negative electrode, and an electrolytic solution, wherein the electrolytic solution is separated from the catalyst layer 14 by the hydroxide ion conductive separator 12 interposed therebetween. A zinc-air secondary battery including a zinc electrode as a metal negative electrode is particularly preferred. Further, a lithium-air secondary battery including a lithium electrode as a metal negative electrode may be used.

### EXAMPLES

The present disclosure will now be explained in more detail with reference to the following examples.

### Example 1

### (1) Preparation of Hydroxide Ion Conductive Composite Material

As a hydroxide ion conductive composite material, Mg—Al-LDH-supported cellulose nanofibers (CNF) (fiber length: from 2 to 50 μm) were prepared by the following procedure. Here, “fiber length: from 2 to 50 μm” means that various fiber lengths distributed in a range from 2 μm to 50 μm are encompassed, and within that, a significant amount (non-negligible amount) of fibers having a length of from 5 to 50 μm and from 10 to 50 μm are included.

### (1a) Preparation of Raw Material Aqueous Solution

As raw materials, 0.025 mol of magnesium nitrate (Mg(NO₃)₂6H₂O, manufactured by Kanto Chemical Co., Inc.), 0.0125 mol of aluminum nitrate (Al(NO₃)₃·6H₂O, manufactured by Kanto Chemical Co., Inc.), and 0.01 g of cellulose nanofibers (CNF) ((C₆H₁₀O₅)ₙ, manufactured by Sugino Machine Limited, IMA-1002, fiber length: from 2 to 50 μm) were weighed out and placed in a beaker, and ion-exchanged water was added to make the total volume 200 ml. The resulting solution was stirred for 30 minutes to prepare a raw material aqueous solution.

### (1b) Preparation of Basic Aqueous Solution

0.05 mol of sodium carbonate (Na₂CO₃, manufactured by Kanto Chemical Co., Inc.) and 0.15 mol of sodium hydroxide (NaOH, manufactured by Fujifilm Wako Pure Chemical Corporation) were dissolved in 100 mL of ion-exchanged water and stirred for 10 minutes to prepare a basic aqueous solution.

### (1c) Coprecipitation Method

200 mL of the raw material aqueous solution was added dropwise into 100 ml of ion-exchanged water at a constant speed using a diaphragm-type metering pump while stirring at 400 rpm. At this time, a pH meter was placed in the reaction solution, and the basic aqueous solution was appropriately added dropwise so that the pH was from 9.5 to 11. After all of the raw material aqueous solution had been added dropwise, the reaction solution was stirred at 60° C. for 5 hours. The reaction solution was then placed in an autoclave and subjected to a hydrothermal treatment at 100° C. for 12 hours to synthesize LDH on the surface of the CNF. Then, purification was performed by centrifugation to obtain Mg—Al-LDH-supported CNF.

### (1d) Identification of LDH by XRD

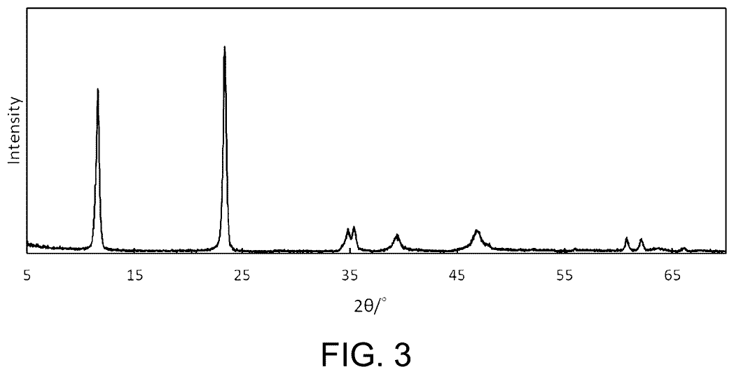

The crystal phase of the Mg—Al-LDH supported on the CNF was measured using an X-ray diffractometer (manufactured by Rigaku Corporation, RINT TTR III) under measurement conditions of a voltage of 50 kV, a current value of 300 mA, and a measurement range of from 10 to 70° to obtain the XRD profile shown in FIG. 3. The obtained XRD profile was identified using the diffraction peak of the LDHs (hydrotalcite compounds) listed in JCPDS card No. 35-0964. The Mg—Al-LDH supported on the CNF was identified as an LDH (hydrotalcite compound).

### (1e) SEM Observation and EDX Quantitative Analysis

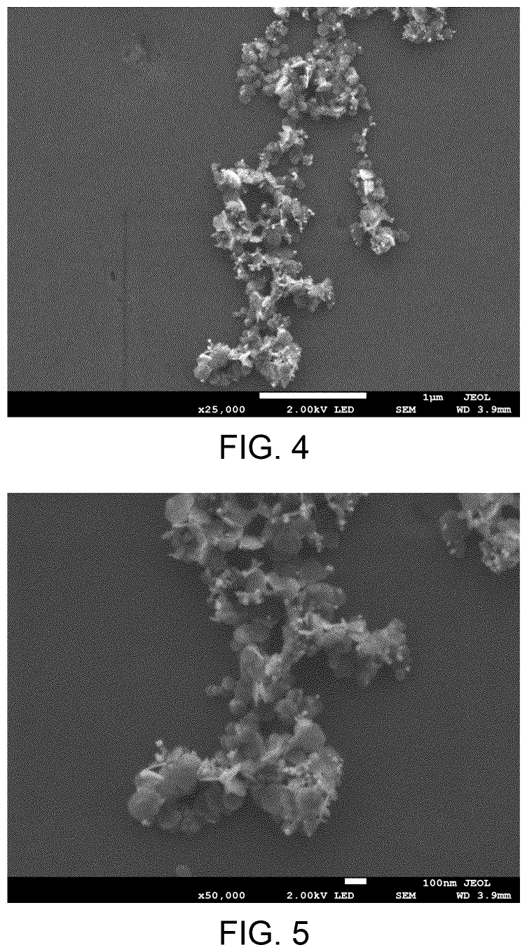

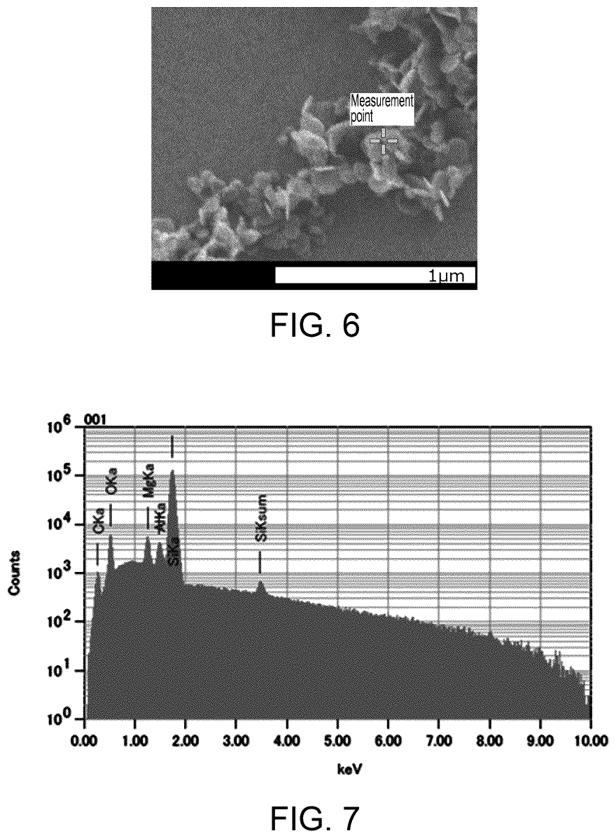

When the Mg—Al-LDH-supported CNF was observed with an SEM at 25000× and 50000× magnification, it was observed that a large number of LDH platy particles were supported on the surface of the CNF with their faces parallel to each other, as shown in FIGS. 4 and 5, respectively. In addition, quantitative analysis was performed on the measurement point shown in FIG. 6 (position where an LDH platy particle existed) using an SEM-EDX (device name: JSM-7900F, manufactured by JEOL Ltd.) under the conditions of an accelerating voltage of 10.0 kV, an irradiation current of 7.47500 nA, a PHA mode of T3, an elapsed time of 108.24 sec, an effective time of 100.00 sec, a dead time of 7%, a counting rate of 16622 cps, and an energy range of from 0 to 20 keV. The results are shown in FIG. 7 and Table 1 below. From these results, it was confirmed that the LDH supported on the CNF was an LDH containing Mg and Al as constituent elements (i.e. Mg—Al-LDH) in an atomic ratio of Al/Mg=0.51.

TABLE 1
ZAF Method, Simple Quantitative Analysis
(Fitting Coefficient: 0.1291)

| Element | (keV) | % by Mass | σ | Atomic Number % |
|---|---|---|---|---|
| C Ka | 0.277 | 4.94 | 0.08 | 10.25 |
| O Ka | 0.525 | 7.55 | 0.08 | 11.77 |
| Mg Ka | 1.253 | 2.07 | 0.03 | 2.12 |
| Al Ka | 1.486 | 1.18 | 0.03 | 1.09 |
| Si Ka | 1.739 | 84.26 | 0.23 | 74.77 |
| Total | | 100 | | 100 |

*Si derived from the sampled substrate

### (1f) Confirmation of Contact State of Hydroxide Ion Conductive Particles

A cross-sectional sample of the catalyst layer was prepared using a cross-section polisher (device name: IB-19520CCP, manufactured by JEOL Ltd.) and observed with an SEM at 25000× and 50000× magnification, from which it was confirmed that the hydroxide ion conductive particles (Mg—Al-LDH particles) were in contact with an adjacent hydroxide ion conductive particle at one or more locations in the catalyst layer and existed in an interconnected state.

### (2) Preparation of Air Electrode/Separator Assembly

2 parts by weight (8 parts by volume) of 25% by weight butyral resin (viscous material obtained by dissolving BL-s manufactured by Sekisui Chemical Co., Ltd. in butyl carbitol) and 50 parts by weight (271 parts by volume) of butyl carbitol were added and kneaded to 14 parts by weight (40 parts by volume) of carbon powder (manufactured by Tokai Carbon Co., Ltd., Toka Black #3855), 8 parts by weight (14 parts by volume) of LDH powder (Ni—Fe—LDH powder prepared by coprecipitation method), 12 parts by weight (26 parts by volume) of the hydroxide ion conductive composite material (Mg—Al-LDH-supported CNF) prepared in (1) above, and 13 parts by weight (12 parts by volume) of platinum-supported carbon (manufactured by Toyo Corporation, EC-20-PTC) with a three-roll rotation/revolution mixer (ARE-310 manufactured by Thinky Corporation) to obtain a paste. The proportion of Mg—Al-LDH-supported CNF in the total solid content (components excluding butyl carbitol) of the obtained paste was 26% by volume. This paste was applied by screen printing onto the surface of an LDH separator (separator obtained by causing Ni—Al—Ti-LDH to precipitate on the inside of the pores and the surface of a polyethylene microporous membrane by hydrothermal synthesis, and roll pressing; thickness: 20 μm) to form a catalyst layer. Before the prepared paste was dry, a gas diffusion electrode (SIGRACET28BC) was placed on the catalyst layer, a weight was placed thereon, and the paste was dried in air at 80° C. for 12 hours to form an air electrode. In this way, an air electrode/separator assembly was obtained.

### (3) Preparation of Zinc Oxide Negative Electrode

100 parts by weight of ZnO powder (manufactured by Seido Chemical Industry Co., Ltd., JIS standard type 1 grade, average particle size D50: 0.2 μm) was added to 5 parts by weight of metallic Zn powder (Mitsui Mining & Smelting Co., Ltd., doped with Bi and In, Bi: 1000 ppm by weight, In: 1000 ppm by weight, and average particle size D50: 100 μm), then 1.26 parts by weight in terms of solid content of polytetrafluoroethylene (PTFE) dispersion solution (manufactured by Daikin Industries, Ltd., solid content 60%) was further added, and the mixture was kneaded with propylene glycol. The resulting kneaded material was rolled using a roll press to obtain a 0.4 mm negative electrode active material sheet. The negative electrode active material sheet was then pressed onto tin-plated copper expanded metal, and dried in a vacuum dryer at 80° C. for 14 hours. The dried negative electrode sheet was cut out so that the portion where the active material was applied was 2 cm square, and a copper foil was welded to the current collector portion to obtain a zinc oxide negative electrode.

### (4) Assembly and Evaluation of Evaluation Cell

The zinc oxide negative electrode was laminated on the LDH separator side of the air electrode/separator assembly. The resulting laminate was clamped in a holding jig with a sealing member tightly biting into the outer periphery of the LDH separator, and firmly fixed with screws. The holding jig had an oxygen inlet on the air electrode side and a liquid injection port through which an electrolytic solution could be introduced on the zinc oxide negative electrode side. A 5.4 M KOH aqueous solution saturated with zinc oxide was charged into the negative electrode side of the assembly thus obtained to form an evaluation cell.

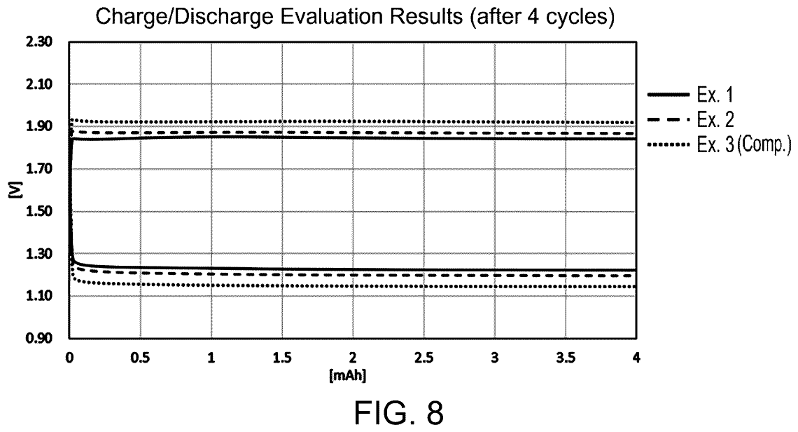

Using an electrochemical measuring device (HZ-Pro S12, manufactured by Hokuto Denko Corporation), the charge/discharge characteristics of the evaluation cell were measured under the following conditions.
Air electrode gas: Water-vapor-saturated (25° C.) oxygen (flow rate 200cc/min)
Charge/discharge current density: 2 mA/cm²
Charge/discharge time: 60 minutes charge/60 minutes discharge
Number of cycles: 4 cycles
   The results are shown in FIG. 8.

### Example 2

The Mg—Al-LDH-supported CNF (fiber length: from 0.2 to 3 μm) were produced and evaluated in the same manner as in Example 1, except that AFo-1002 (fiber length: from 0.2 to 3 μm) manufactured by Sugino Machine Limited were used as the cellulose nanofibers ((C6H1005) n) instead of IMA-1002. As a result, the Mg—Al-LDH supported on the CNF was identified as an LDH (hydrotalcite compound) by XRD. In addition, SEM observation showed that a large number of LDH platy particles were supported on the surface of the CNF with their faces parallel to each other. Further, it was confirmed by SEM-EDX that the LDH supported on the CNF was an LDH containing Mg and Al (i.e. Mg—Al-LDH) as constituent elements in an atomic ratio of Al/Mg =0.51. In addition, when the contact state of the hydroxide ion conductive particles was checked in the same manner as in Example 1, it was confirmed that in the catalyst layer produced in this example, the hydroxide ion conductive particles (Mg—Al-LDH particles) were in contact with an adjacent hydroxide ion conductive particle at one or more locations in the catalyst layer and existed in an interconnected state.

Next, an air electrode/separator assembly and an evaluation cell were prepared and evaluated in the same manner as in Example 1 using Mg—Al-LDH-supported CNF. The results of the charge/discharge evaluation are shown in FIG. 8. From FIG. 8, it was found that the evaluation cells (zinc-air secondary batteries) prepared in Examples 1 and 2 have a configuration in which Mg—Al-LDH-supported CNF was used as the hydroxide ion conductive composite material in the catalyst layer of the air electrode, and the increase in charge/discharge overvoltage was suppressed compared to Example 3, described later, in which Mg—Al-LDH (without CNF) was used. In particular, the charge/discharge overvoltage was smaller in Example 1 (CNF fiber length: from 2 to 50 μm) than in Example 2 (CNF fiber length: from 0.2 to 3 μm), and thus it was found that the longer the CNF fiber length, the better the effect of the hydroxide ion conductive composite material was and the greater the suppression of an increase in charge/discharge overvoltage was.

### Example 3 (Comparison)

A hydroxide ion conductive material, an air electrode/separator assembly, a zinc oxide negative electrode, and an evaluation cell were prepared and evaluated in the same manner as in Example 1, except that Mg—Al-LDH powder (not supported on CNF) was prepared without adding cellulose nanofibers and used instead of Mg—Al-LDH-supported CNF. When the contact state of the hydroxide ion conductive particles was confirmed in the same manner as in Example 1, it was confirmed that in the catalyst layer produced in this comparative example, the hydroxide ion conductive particles (Mg—Al-LDH particles) were not necessarily in contact with other hydroxide ion conductive particles, but existed in a dispersed state. In addition, the charge/discharge evaluation results were as shown in FIG. 8. From FIG. 8, it was found that in the evaluation cell produced in this example, because the hydroxide ion conductive material (Mg—Al-LDH) was not supported on the CNF and the LDH platy particles were not continuous such that their faces were parallel to each other, the increase in charge/discharge overvoltage was large when the charge/discharge evaluation was performed.

What is claimed is:

1. An air electrode/separator assembly comprising:
a hydroxide ion conductive separator;
a catalyst layer that covers one side of the hydroxide ion conductive separator and comprises an air electrode catalyst, a hydroxide ion conductive composite material, an electrically conductive material, and a binder; and
a gas diffusion electrode arranged on the catalyst layer opposite to the hydroxide ion conductive separator side, wherein
the hydroxide ion conductive composite material comprises:
hydrophilic fibers; and
a plurality of hydroxide ion conductive particles supported on a surface of the hydrophilic fibers in an interconnected manner.

2. The air electrode/separator assembly according to claim 1, wherein the hydrophilic fibers are at least one selected from the group consisting of cellulose nanofibers, chitin nanofibers, and chitosan nanofibers.

3. The air electrode/separator assembly according to claim 1, wherein the hydrophilic fibers are cellulose nanofibers.

4. The air electrode/separator assembly according to claim 1, wherein the hydrophilic fibers have a length of from 0.1 to 100 μm.

5. The air electrode/separator assembly according to claim 1, wherein the hydrophilic fibers have a length of from 0.2 to 50 μm.

6. The air electrode/separator assembly according to claim 1, wherein the hydrophilic fibers have a length of from 5 to 50 μm.

7. The air electrode/separator assembly according to claim 1, wherein the hydroxide ion conductive particles are composed of a layered double hydroxide (LDH).

8. The air electrode/separator assembly according to claim 7, wherein the layered double hydroxide (LDH) comprises at least two elements selected from the group consisting of Ni, Fe, Mg, Al, and Ti as constituent elements.

9. The air electrode/separator assembly according to claim 8, wherein the at least two elements comprise Mg and Al.

10. The air electrode/separator assembly according to claim 1, wherein a content of the hydroxide ion conductive composite material in the catalyst layer is from 10 to 40% by volume based on a total amount in terms of solid matter of the air electrode catalyst, the hydroxide ion conductive composite material, the electrically conductive material, and the binder.

11. The air electrode/separator assembly according to claim 1, wherein a content of the hydroxide ion conductive composite material in the catalyst layer is from 10 to 30% by volume based on a total amount in terms of solid matter of the air electrode catalyst, the hydroxide ion conductive composite material, the electrically conductive material, and the binder.

12. The air electrode/separator assembly according to claim 1, wherein the hydroxide ion conductive separator is a layered double hydroxide (LDH) separator.

13. The air electrode/separator assembly according to claim 12, wherein the LDH separator is composited with a porous substrate.

14. A metal-air secondary battery comprising:
the air electrode/separator assembly according to claim 1;
a metal negative electrode; and
an electrolytic solution, wherein
the electrolytic solution is separated from the air electrode layer by the hydroxide ion conductive separator interposed therebetween.
